(19) United States
(12) Patent Application Publication
(10) Pub. No.: US 2019/0370819 A1
(43) Pub. Date: Dec. 5, 2019

(54) PRICE MINING PREVENTION AND MINIMUM ADVERTISED PRICING POLICY COMPLIANCE MANAGEMENT DATA PROCESSING SYSTEMS AND METHODS

(71) Applicant: Viesoft, Inc., Walnut Creek, CA (US)

(72) Inventor: Anthony Vierra, Walnut Creek, CA (US)

(21) Appl. No.: 16/542,630

(22) Filed: Aug. 16, 2019

Related U.S. Application Data
(63) Continuation-in-part of application No. 15/379,137, filed on Dec. 14, 2016, now Pat. No. 10,389,752.
Application No. 15/379,137 is a continuation-in-part of application No. 14/597,029, filed on Jan. 14, 2015, now Pat. No. 9,552,487.

(51) Int. Cl. G06Q 30/00; G06Q 30/02; G06Q 30/06

(52) U.S. Cl. CPC G06Q 30/018; G06Q 30/0601; G06Q 30/0283

(57) ABSTRACT

Price mining and minimum advertised pricing policy compliance management data processing systems and methods are disclosed. A system and method that is configured to: (1) communicate from a manufacturer to one or more retailers a minimum advertised pricing policy, (2) update the minimum advertised pricing policy in real time, (3) allow a retailer to check whether a current or proposed price violates the manufacturer's current minimum advertised pricing policy; and (4) allow the retailer to determine if a competitor is violating the manufacturer's current minimum advertised pricing policy. In various embodiments, the retailer can report a competitor's violation of the manufacturer's current minimum advertised pricing policy and the system is further configured to allow the manufacturer and competitor to communicate and resolve the potential manufacturer's current minimum advertised pricing policy violation.

### CROSS-REFERENCE TO RELATED APPLICATIONS

This application is a continuation-in-part of U.S. patent application Ser. No. 15/379,137, filed Dec. 14, 2016, which is a continuation-in-part of U.S. patent application Ser. No. 14/597,029, filed Jan. 14, 2015, now U.S. Pat. No. 9,552,487, both of which are entitled “Price Mining Prevention Systems and Related Methods,” and both of which are hereby incorporated by reference in their entireties.

### BACKGROUND

Online retailers and others may desire to price products they offer in a competitive manner to improve sales. Such retailers may further desire to prevent competitors from undercutting their prices. Accordingly, there is a need for improved systems and methods that address these needs.

In general, manufacturers set minimum advertised price (“MAP”) policies in an effort to main consistency in pricing. Typically, there are no structured ways to communicate current MAP policies or updates to these MAP policies to retailers of the manufacturer's products. In addition, manufacturers may or may not have effective programs for policing MAP policies. Thus, if MAP policies are not effectively enforced, complying retailers may become disgruntled and may even potentially stop complying. Currently, it takes manufacturers significant time and effort to police, monitor, and enforce MAP policies. Also, it takes retailers a significant amount of time and effort to stay up to date and to comply with various manufacturers' individual MAP policies.

### SUMMARY

A non-transitory computer-readable medium storing computer-executable instructions for processing unwanted access source data associated with price mining on an online retail website by: (A) detecting, by one or more computer processors, an access to a particular web page containing pricing information; (B) determining, by one or more computer processors, whether a source of the access is an individual employed by one or more competitors of a company that owns the particular web page being accessed; and (C) at least partially in response to determining that the individual is employed by one or more competitors of a company that owns the particular web page being assessed, taking, by one or more computer processors, one or more defensive actions against the source of the access.

A computer-implemented method for processing unwanted access source data associated with price mining on an online retail website, the computer-implemented method comprising the steps of: (A) detecting, by one or more computer processors, an access to a particular web page containing pricing information; (B) determining, by one or more computer processors, whether a source of the access is an individual that is employed by one or more competitors of a company and that owns the particular web page being accessed; (C) determining, by one or more computer processors, a job title of the individual; (D) determining, by one or more computer processors, based on the job title, that the individual should be prohibited from obtaining pricing information from the online retail website; and (E) in response to determining that the individual should be prohibited from obtaining pricing information from the online retail website, taking, by a processor, one or more defensive actions against the source of the access.

In general, in various embodiments, a computer system for processing managing compliance data associated with one or more minimum advertised pricing policies includes at least one processor and memory, wherein the computer system is configured for: (1) receiving a first set of data that includes MAP information for a particular product made by a manufacturer, the MAP information reflecting at least a portion of a MAP policy established by the manufacturer; (2) storing the first set of data in the memory; (3) receiving a request from a user to confirm that a particular price for the particular product complies with the MAP policy; (4) at least partially in response to receiving the request, using the first set of data to determine whether the particular price for the particular product complies with the MAP policy; (5) at least partially in response to determining that the particular price for the particular product complies with the MAP policy, informing the user that the particular price for the particular product complies with the MAP policy; and (6) at least partially in response to determining that the particular price for the particular product does not comply with the MAP policy, informing the user that the particular price for the particular product does not comply with the MAP policy.

In an illustrative embodiment, a method of processing minimum advertised pricing policy data includes (1) providing access, by a plurality of retailers and at least one manufacturer, to a centralized computer system; (2) receiving, via the computer system, an indication by a first one of the retailers that a second one of the retailers has potentially violated a MAP policy associated with the manufacturer; (3) at least partially in response to the computer system receiving the indication, using the computer system to inform the manufacturer that the second retailer has potentially violated a MAP policy; and (4) using the computer system to facilitate communication between the second retailer and the manufacturer regarding the second retailer's potential violation of the MAP policy.

In an illustrative embodiment, a computer system for managing processing minimum advertised pricing policy data includes at least one processor and memory, wherein the computer system is configured for: (1) receiving a first set of data that includes MAP information for a particular product made by a manufacturer, the MAP information reflecting at least a portion of a MAP policy established by the manufacturer; (2) at least partially in response to receiving the first set of data, storing the first set of data in the memory and transmitting the first set of data to a plurality of retailers that are currently selling the product; (3) receiving a second set of data that includes updated MAP information for the particular product; and (4) at least partially in response to receiving the second set of data, storing the second set of data in the memory and transmitting the second set of data to a plurality of retailers that are currently selling the product.

In an illustrative embodiment, a computer system for processing minimum advertised pricing policy data includes at least one processor and memory, wherein the computer system is configured for: (1) receiving a first set of data that includes MAP information for a particular product made by a manufacturer, the MAP information reflecting at least a portion of a MAP policy established by the manufacturer; (2) storing the first set of data in the memory; (3) receiving pricing data for the particular product from a website associated with a particular retailer; (4) at least partially in response to receiving the pricing data, using the first set of data to determine whether the particular price for the particular product complies with the MAP policy; and (5) at least partially in response to determining that the particular price for the particular product does not comply with the MAP policy, informing the particular retailer that the particular price for the particular product does not comply with the MAP policy.

### BRIEF DESCRIPTION OF THE DRAWINGS

Various embodiments of a system and method for pricing products are described below.

In the course of this description, reference will be made to the accompanying drawings, which are not necessarily drawn to scale, and wherein:

FIG. 1 is a block diagram of a system in accordance with an embodiment of the present system.

FIG. 2 is a schematic diagram of a computer, such as the system of FIG. 1, that is suitable for use in various embodiments.

FIG. 3 depicts a flow chart that generally illustrates various steps executed by an automated access determination module that, for example, may be executed by the system of FIG. 1.

FIG. 4 depicts a flow chart that generally illustrates various steps executed by an unwanted human access determination module that, for example, may be executed by the system of FIG. 1.

FIG. 5 depicts a flow chart that generally illustrates various steps executed by a price mining prevention module that, for example, may be executed by the system of FIG. 1.

FIG. 6. depicts a flow chart that generally illustrates various steps executed by a minimum advertised price compliance communication module that, for example, may be executed by the system of FIG. 1.

FIG. 7 depicts a flow chart that generally illustrates various steps executed by a minimum advertised price compliance policing module that, for example, may be executed by the system of FIG. 1.

FIG. 8 depicts a flow chart that generally illustrates various steps executed by a minimum advertised price compliance reporting and enforcing module that, for example, may be executed by the system of FIG. 1.

FIG. 9 depicts a flow chart that generally illustrates various steps executed by a minimum advertised price compliance monitoring module that, for example, may be executed by the system of FIG. 1.

FIG. 10 depicts an example of a user interface showing a particular retailer's price grid that tracks and displays minimum advertised price compliance.

FIGS. 11A-C depict examples of a user interface that allow a retailer to check pricing against a manufacturer's minimum advertised price, check competitor pricing against a manufacturer's minimum advertised price, and submit potential minimum advertised price violations to the manufacturer.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

Various companies may attempt to mine data from websites and other sources about their competitors using bots and/or people to access the data. This data may include, for example, product data, pricing data, and other suitable data associated with one or more products offered for sale via a particular web page. In particular embodiments, a price mining prevention system may be configured to detect and analyze website access and enable website administrators to implement one or more defenses to prevent unwanted access. In various embodiments, the system may, for example: (1) detect access to a web page from a particular source; (2) determine whether the particular source may be an unwanted source; and (3) at least partially in response to determining that the particular source is an unwanted source, take a defensive action against the particular source (e.g., by blocking further access from that particular source).

In particular embodiments, the system may be configured to determine that a particular access of a web page is a potentially unwanted access based at least in part on: (1) an IP address from which the web page was accessed (e.g., a particular competitor may own a particular range of one or more IP addresses and the accessing IP address may be within that particular range); (2) a zip code associated with an IP address from which the web page was accessed (e.g., because a particular competitor may have offices or be headquartered at that zip code); (3) a user associated with the IP address from which the web page was accessed (e.g., the user may be an employee of a competitor or associated with a competitor); (4) an access pattern from a particular IP address (e.g., systematic access from a particular IP address); and/or (5) any other suitable factor.

In various embodiments, the system is configured to track access to one or more websites (e.g., one or more related websites associated with a particular company). The system may then identify access patterns (e.g., from a particular IP address) in order to determine whether a particular access is substantially automated. The system may make this determination based at least in part on: (1) frequency of access (e.g., how often the website is accessed); (2) number of particular web pages accessed; and/or (3) any other suitable factor.

In particular embodiments, at least partially in response to determining that a particular access may be substantially automated (e.g., the access may be by a bot rather than a human user), the system may be configured to verify that the access is by a human by requiring completion of one or more Completely Automated Public Turing Tests to tell Computers and Humans Apart (CAPTCHA). In other embodiments, the system may be configured to substantially automatically block access from a source determined to be substantially automated.

In other embodiments, the system may be configured to substantially prevent access to one or more particular web pages by particular human users (e.g., in addition to automated bots). For example, the system may be configured to block access to one or more particular web pages by employees or other persons associated with a particular company who may be attempting to access web pages to ascertain data such as the data described above. In various embodiments, the system may be configured to identify individuals accessing a particular web page as individuals associated with a competitor by, for example: (1) requiring individuals accessing the particular web page to register an account; and (2) using a particular individual's account information to determine if the individual is a known employee of a competitor (e.g., because the individual is listed as an employee on the competitor's web page or other publicly available employee list).

In various embodiments, the system may be configured to determine that a particular individual is an employee of or otherwise associated with a competitor based at least in part on social networking data associated with the particular individual. For example, the system may search one or more social networks for users that have registered with a similar name or email address as a particular individual that has registered for an account with their web page. The system may then be configured to mine any associated social network accounts (e.g., Facebook, Twitter, Foursquare, Instagram, etc.) to determine an employer of the particular individual as well as any other potentially useful information about the individual.

In various embodiments, the system is configured to analyze website access and determine and implement particular defensive measures (e.g., blocking, CAPTCHA requirement, etc.) substantially in real time. In other embodiments, the system is configured to review and analyze access data from a log of access information at a later time from when the access occurred.

In particular embodiments, the system is embodied as a plugin for a particular website that is offered as a service provided by a price mining prevention company. In various embodiments, the system (or the price mining prevention company) may track access by all customers of the service, which may, for example, enable the price mining prevention company to determine unwanted access, which may come from one or more non-competitor sources (e.g., access from third party companies hired by competitors of their companies to monitor pricing data).

In various embodiments, a price mining prevention system may enable websites to at least substantially reduce unwanted web traffic to their websites. In particular embodiments, the system may enable websites to substantially prevent competitors from accessing pricing and other data available on their websites.

A MAP compliance system according to various embodiments is adapted to: (A) facilitate communication of MAP information between manufacturers and retailers; (B) facilitate policing of current MAP policies by both manufacturers and retailers; (C) encourage compliance with current MAP policies; and (D) facilitate communication between retailers who are allegedly violating current MAP policies in order to either end the violation of the policies or to resolve a misunderstanding, on behalf of the manufacturer, that the retailer is in violation of a MAP policy when, in fact, no violation has occurred.

In particular embodiments, in facilitating the communication of MAP information between manufacturers and retailers, the system is adapted to receive a first set of data about a particular MAP for a particular product. The MAP information will include information such as the specific product, the specific price, and other information related to when and how the price can be changed. After receiving the MAP information, the system is adapted to store the MAP information and transmit this information to all retailers currently selling the particular product. If the manufacturer updates the MAP policy for a particular product, the system will receive a second set of data that includes the updated MAP information. As with the first set of data, the system will store and transmit the information pertaining to the second set of data directly to the retailers currently selling the particular product. This information may be transmitted via electronic communication such as an instant message, email, or a pop-up notification on the retailer's computer.

The system is also adapted to receive requests from the retailers to verify current or proposed pricing schedules for a particular product. The retailers may also verify pricing schedules of competitors that are also using the system. In verifying these pricing schedules, the system will first receive data relating to the current MAP for a particular product from a manufacturer and store this data until a request has been made by a retailer. Once the retailer makes a request to confirm the pricing schedule, the system will compare the retailer's price with the MAP, as stated by the manufacturer. If the retailer's price is above or equal to the MAP, the system will notify the retailer that the retailer's price complies with the manufacturer's MAP. However, if the retailer's price is below the MAP, the system will notify the retailer that the retailer's price does not comply with the manufacturer's MAP.

The system is further adapted to allow retailers to police other retailers' pricing activities. For example, one retailer may use the system to determine whether its competitor is meeting or exceeding the MAP set by the manufacturer for a particular product sold by the retailers. If the competitor's price is lower than the manufacturer's MAP, the retailer may use the system to notify the manufacturer that the competitor's price does not comply with the manufacturer's MAP. The system may then allow the competitor and the manufacturer to resolve the discrepancy and potentially notify other retailers of the resolution.

In addition, the system is further adapted to permit manufacturers to police retailers' pricing activities for particular products. For example, the system will receive a particular retailer's price for a particular product directly from the retailer's website. After receiving the information from the retailer's website, the system may send a notification to the retailer stating that the retailer's price for the particular product either does or does not comply with the manufacturer's MAP policy. In addition, the system may inform the manufacturer of non-complying retailers.

### Example Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects.

Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

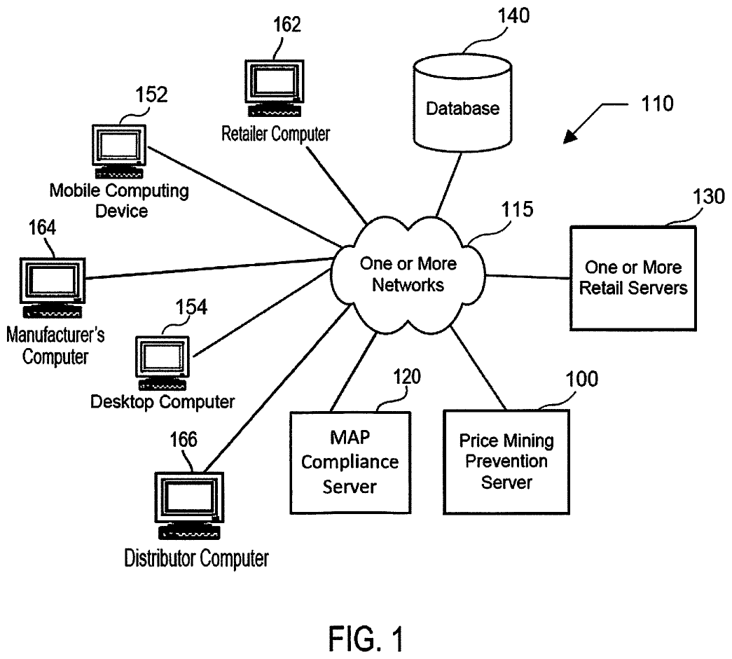

FIG. 1 is a block diagram of a System 110 according to a particular embodiment. As may be understood from this figure, the System 110 includes One or More Networks 115, a Price Mining Prevention Server 100, a MAP Compliance Server 120, One or More Retail Servers 130, a Database 140, one or more remote computing devices, such as a Mobile Computing Device 152 (e.g., a smart phone, a tablet computer, a wearable computing device, a laptop computer, etc.), a Desktop Computer 154, a Retailer Computer 162, a Manufacturer Computer 164, and/or a Distributor Computer 166. In particular embodiments, the One or More Networks 115 facilitate communication between any of the Price Mining Prevention Server 100, One or More Retail Servers 130, the Database 140, the MAP Compliance Server 120, and the one or more remote computing devices 152, 154, 162, 164, 166.

The One or More Networks 115 may include any of a variety of types of wired and/or wireless computer networks such as the Internet, a private intranet, a mesh network, a public switch telephone network (PSTN), or any other type of network (e.g., a network that uses Bluetooth or near field communications to facilitate communication between computers). The communication link between the Price Mining Prevention Server 100 and Database 140 may be, for example, implemented via a Local Area Network (LAN) or via the Internet. In another example, the communication link between the MAP Compliance Server 120 and Database 140 may be, for example, implemented via a Local Area Network (LAN) or via the Internet. In yet another example, any of the one or more remote computing devices 152, 154, 162, 164, 166 may communicate with Database 140 and/or the MAP Compliance Server 120 via a Local Area Network (LAN) or via the Internet.

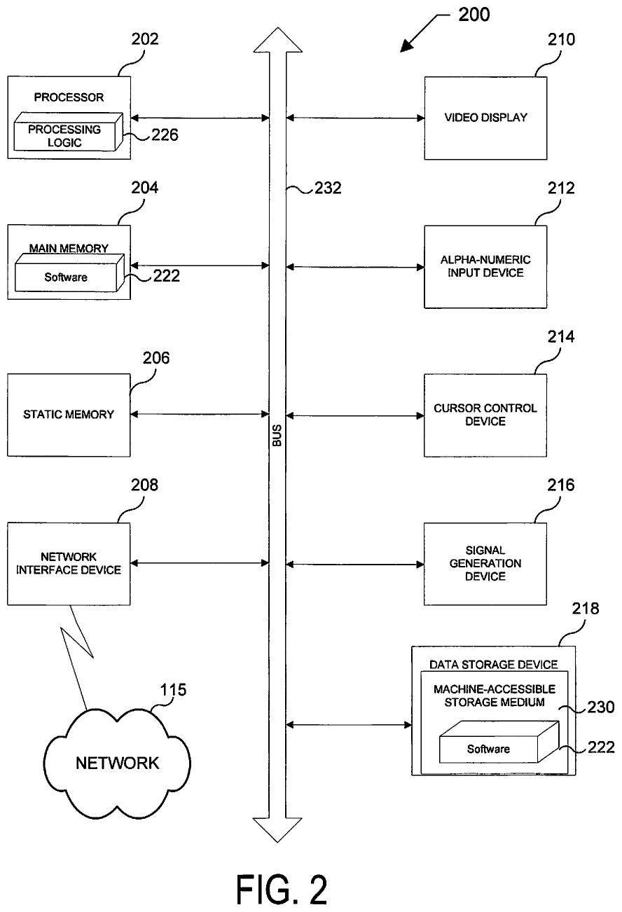

FIG. 2 illustrates a diagrammatic representation of a Computer 200 that can be used within the System 110, for example, as a client computer (e.g., one of the remote computing devices 152, 154, 162, 164, 166 shown in FIG. 1), or as a server computer (e.g., Price Mining Prevention Server 100, MAP Compliance Server 120 shown in FIG. 1). In particular embodiments, the Computer 200 may be suitable for use as a computer within the context of the System 110 that is configured for collecting, tracking, and storing price mining prevention data. In other embodiments, the Computer 200 may be suitable for use as a computer within the context of the System 110 that is configured for collecting, tracking, and storing MAP compliance data. In various embodiments, the Computer 200 may be suitable for performing one or more functions of a Price Mining Prevention Server 100, a MAP Compliance Server 120, or may perform functions of both a Price Mining Prevention Server 100 and a MAP Compliance Server 120.

In particular embodiments, the Computer 200 may be connected (e.g., networked) to other computers in a LAN, an intranet, an extranet, and/or the Internet. As noted above, the Computer 200 may operate in the capacity of a server or a client computer in a client-server network environment, or as a peer computer in a peer-to-peer (or distributed) network environment. The Computer 200 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An example Computer 200 includes a Processor 202, a Main Memory 204 (e.g., read-only memory (ROM), flash memory, dynamic random access memory (DRAM) such as synchronous DRAM (SDRAM) or Rambus DRAM (RDRAM), etc.), a Static Memory 206 (e.g., flash memory, static random access memory (SRAM), etc.), and a Data Storage Device 218, which may communicate with each other via a Bus 232.

The Processor 202 represents one or more general-purpose or specific processing devices such as a microprocessor, a central processing unit, and the like. More particularly, the Processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The Processor 202 may also be one or more special-purpose processors such as an application specific integrated circuit (ASIC), a field programmable gate array (FPGA), a digital signal processor (DSP), a network processor, and the like. The Processor 202 may be configured to execute Processing Logic 226 for performing various operations and steps discussed herein.

The Computer 200 may further include a Network Interface Device 208. The Computer 200 may also include a Video Display 210 (e.g., a liquid crystal display (LCD) or a cathode ray tube (CRT)), an Alpha-Numeric Input Device 212 (e.g., a keyboard), a Cursor Control Device 214 (e.g., a mouse), and a Signal Generation Device 216 (e.g., a speaker).

The Data Storage Device 218 may include a Machine-Accessible Storage Medium (e.g., a non-transitory computer-accessible storage medium) 230 (also known as a non-transitory computer-readable storage medium or a non-transitory computer-readable medium) on which is stored one or more sets of instructions (e.g., Software 222) embodying any one or more of the methodologies or functions described herein (e.g., Automated Access Determination Module 300, Unwanted Human Access Determination Module 400, Price Mining Prevention Module 500, MAP Compliance Communications Module 600, MAP Compliance Policing Module 700, MAP Compliance Reporting and Enforcing Module 800, MAP Compliance Monitoring Module 900). The Software 222 may also reside, completely or at least partially, within the Main Memory 204 and/or within the Processor 202 during execution thereof by the Computer 200, with the Main Memory 204 and/or the Processor 202 also constituting computer-accessible storage media. The Software 222 may further be transmitted or received over One or More Networks 115 via a Network Interface Device 208.

While the Machine-Accessible Storage Medium 230 is shown in an example embodiment to be a single medium, the terms “computer-accessible storage medium” and “computer-readable medium” should be understood to include a single medium or multiple media (e.g., a centralized or distributed database, and/or associated caches and servers) that store the one or more sets of instructions. The terms “computer-accessible storage medium” and “computer-readable medium” should also be understood to include any medium (e.g., non-transitory medium) that is capable of storing, encoding, or carrying a set of instructions for execution by the Computer 200 and that cause the Computer 200 to perform any one or more of the methodologies of the present invention. The terms “computer-accessible storage medium” and “computer-readable medium” should accordingly be understood to include, but not be limited to, solid-state memories, optical and magnetic media, etc.

### Example System Platform

Various embodiments of a system for preventing price and other data mining on one or more online retail websites and for MAP compliance according to various embodiments are described below and may be implemented in any suitable context. Various aspects of the system's functionality may be executed by certain system modules, including Automated Access Determination Module 300, Unwanted Human Access Determination Module 400, Price Mining Prevention Module 500, MAP Compliance Communications Module 600, MAP Compliance Policing Module 700, MAP Compliance Reporting and Enforcing Module 800, and MAP Compliance Monitoring Module 900. These modules are discussed in greater detail below.

It should be understood by reference to this disclosure that the methods describe an exemplary embodiments of method steps carried out by the present system, and that other exemplary embodiments may be created by adding other steps, by removing one or more of the method steps, or performing one or more of the method steps in an order other than the order in which they described in figures. Exemplary functionality of certain embodiments of the system is described below.

Automated Access Determination Module

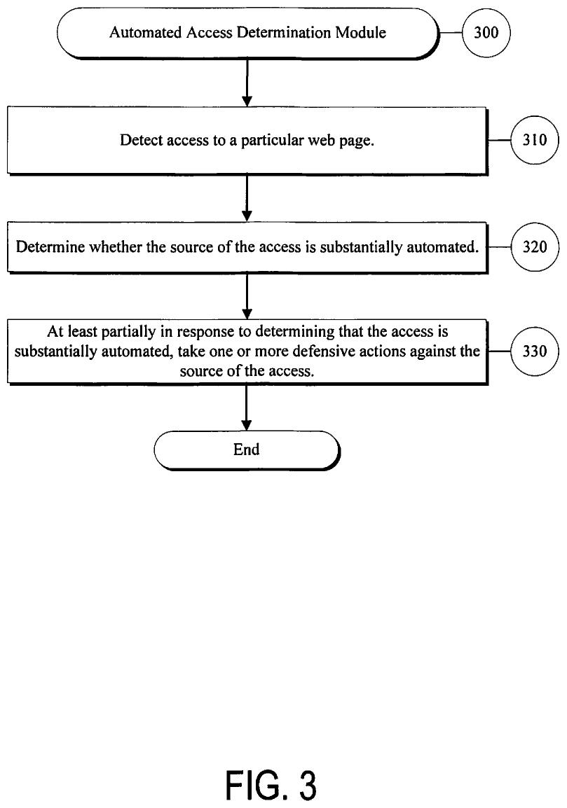

FIG. 3 is a flow diagram of an exemplary Automated Access Determination Module 300.

The Automated Access Determination Module 300 may, for example, be implemented by a computer system such as the System 110 of FIG. 1. Returning to FIG. 3, at Step 310, the system begins by detecting access to a particular web page. In various embodiments, the system is configured to detect access in response to receiving a request to access the particular web page. The request to access the web page may occur when the web page is accessed from a link provided by a search engine, when the web page is accessed from an advertising link on a separate web page, or when the web page is accessed directly by the web page address being entered into the address bar of a suitable internet browser.

When the system detects access to the web page at Step 310, the system may, for example, collect data associated with the source of the access such as the IP address, the operating system information, the web browser information, the user agent string, the search terms used to access the web page, the advertising link used to access the web page, or other information relating to the method used to access the web page or the source of the access.

The system then advances to Step 320, where it determines, at least partially based on the data associated with the source of the access, whether the source of the access may be substantially automated. In various embodiments, the system is configured to detect substantially automated access such as by one or more bots or one or more web crawlers. The system may use the data associated with the source of the access to determine that the access is substantially automated by retrieving information on access patterns of the source of the access. Such access patterns may include the frequency of the access and the number of web pages accessed within a particular website. For instance, if the access pattern shows that a particular IP address frequently accesses the same web page, the system may determine that the source of the access is automated. In addition, if the system detects that a particular IP address accesses every web page of a particular website, the system may also determine that the source of the access is automated.

Access patterns may also include similar access patterns based on other factors than the data associated with the source. For instance, the system may determine access patterns based on frequent access to web pages for particular products, for instance, an Apple iPad Air, or for particular types of products, for instance, a tablet computing device. The system may, for example, be configured to determine that a particular access is substantially automated based at least in part on determining that a source of access accesses one or more products from a particular class of products during a particular access of a particular website.

For example, a source of access may access one or more web pages of a particular online retail website during a particular visit. The system may determine, for example, that the source of access has accessed a greater number of product pages during a particular visit than a typical user (e.g., a typical online shopper) would access during a typical visit. For example, the system may determine that a typical user, when shopping for televisions, visits a product page for a particular number of televisions before making a purchase (e.g., the user may view information for between about 4 and about 6 televisions before making a purchase). In such embodiments, the system may determine that a source of access that views product and pricing information for more than about ten different televisions during the visit is likely to be a substantially automated access (e.g., because a typical user would not likely have viewed so many televisions during a single visit). In various embodiments, the system may determine that a source of access viewing product information for such a large number of products is more likely to be a source that is simply substantially automatically mining data rather than a legitimate user of the website.

In advancing to Step 330, the system then, at least partially in response to determining that the access is substantially automated, takes one or more defensive actions against the source of the access. In various embodiments, the defensive action may include determining whether the source of the access is a human. In various embodiments, the system may determine whether the source is a human by requiring registration of a user account to continue to access the web page. If no user account is created, the system may deny access to the web page from the particular source. In other embodiments, the system may require completion of a CAPTCHA before the source can continue to access the web page. At least partially in response to determining that the source of the access has not completed the CAPTCHA, the system may deny access to the web page. In still other embodiments, the system may take any other suitable defensive action to verify that the source is a human and not an automated source.

Unwanted Human Access Determination Module

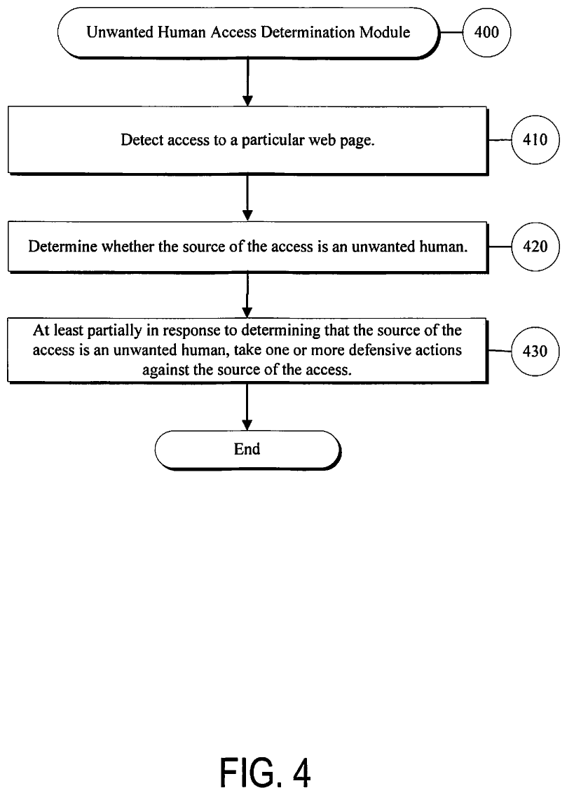

FIG. 4 is a flow diagram of an exemplary Unwanted Human Access Determination Module 400. The Unwanted Human Access Determination Module 300 may, for example, be implemented by a computer system such as the System 110 of FIG. 1. Turning again to FIG. 4, the system begins at Step 410 by detecting access to a particular web page. In various embodiments, the system is configured to detect access in response to receiving a request to access the particular web page. The request to access the web page may occur when the web page is accessed from a link provided by a search engine, when the web page is accessed from an advertising link on a separate web page, when the web page is accessed directly from the web page address being entered into the address bar of a suitable internet browser, or in any other suitable way.

When the system detects access to the web page at Step 410, the system, in various embodiments, collects data associated with the source of the access such as: (1) IP address information; (2) operating system information; (3) web browser information; (4) one or more user agent strings; (5) one or more search terms used to identify and/or access the web page; (6) an advertising link used to access the web page; and/or (7) other information relating to the method used to access the web page and/or the source of the access. The system may, in particular embodiments, collect other information about the source of the access including an email address if the source has a registered account for the web page, or other information associated with the registered account such as, for example, a name of the user, an address of the user, etc.

Proceeding to Step 420, the system determines, based at least in part on information associated with the source of the access, whether the source of the access may be an unwanted human. The system may gather this information, for example, from the IP address of the source, the email address if the source has a registered account with the web page, the operating system of the source, the web browser information of the source, the user agent string of the source, or any other suitable information. In a particular embodiment, the system is configured to determine a location (e.g., a particular city or area from which the source of the access originates) of the source of the access (e.g., based at least in part on an IP address of the source) and further determine whether the determined location may be a location from which access is not desired. For example, the system may determine that the location of the source is a location associated with a particular competitor, particular independent company that is known for providing price-mining or other data-mining services, etc. The system may, in response to making such a determination, determine that the source is an unwanted one.

In various embodiments, the source of the access may register or have a registered account for the web page the user is accessing that is the same email address used on another web site such as a social networking site, a professional networking site, or other website (e.g., Facebook, LinkedIn, Twitter, Google, Spokeo, Pipl, county tax assessor's property records, etc.). The system, in various embodiments, may then conduct a search (e.g., an automated search) of these websites in order to determine, for example, the source's name, alma mater(s), occupation, one or more businesses the source is following (e.g., on the social media website), one or more groups the source is a part of, one or more businesses where the source has “checked in,” current and past employers of the source, one or more addresses of the source, one or more neighbors of the source based on the current or previous address, one or more friends or connections of the source, one or more relatives of the source, the current and past employers of the neighbors and/or friends or relatives, etc.

After gathering the information on the source of the access, the system may determine that the source accessing the web page may be an unwanted human based on the source being an employee or independent contractor of a competitor, a friend of an employee of a competitor, a relative of an employee of a competitor, a neighbor of an employee of a competitor, or any other person that is likely to be attempting to gain access to the web page for pricing or other information. For example, if the system determines that the same email address used to register at the website was the same email address linked to a specific Facebook account, the system may (e.g., at least substantially automatically) access the source's Facebook page to determine the employer of the source of the access. In a particular example, in response to the system determining that the employer of the source of the access is a competitor to the owner of the web page being accessed, the system may determine that the source of the access is an unwanted human. Similarly, the system may also be configured to see employers of the friends of the source of the access who do not have such access protected with privacy settings. In response to the system determining that the employer of the friend of the source of the access is a competitor to the owner of the web page being accessed, the system may determine that the source of the access is an unwanted human.

In particular embodiments, the system is further configured to determine that the source of the access is an unwanted human based, at least in part, on other information related to the source. For instance, in response to the system determining that the IP address is associated with owned by a competitor, the system may determine that the source is an unwanted human. In addition, if the email address of the source of the access is owned by a competitor, the system may determine that the source is an unwanted human. In other embodiments, the system may be configured to determine whether a domain associated with the email address of the source is associated with a potential competitor, or one or more potential third party companies that a competitor may have contracted with to mine pricing information and other data. The system may, for example, conduct a string search of an email address associated with the source to determine whether the name of a particular entity is included in the e-mail address or the e-mail domain. In various embodiments, the one or more third party companies may include, for example, one or more law firms, one or more auditing companies, one or more price consulting companies, or any other company which may be mining pricing data. Furthermore, if the geographic region associated with the IP address of the source of the access is similar to or the same as the geographic region where a competitor has an office, the system may determine that the source is likely to be an unwanted human.

In the next step, Step 430, the system, at least partially in response to determining that the source of the access is an unwanted human, takes one or more defensive actions against the source of the access. In various embodiments, the defensive action can be to block the source of the access to the web page. The system may block the source by blocking the IP address associated with the unwanted human. In other embodiments, the system may, for example, limit a number of access by the particular source determined to have been an unwanted human (e.g., to only 1, 2, 3, 4, 5 or other predetermined number of visits within a particular time period, such as per day). In particular embodiments, the system is configured to limit a number of accesses by a source determined to have been an unwanted human to between one and ten accesses per day (e.g., 2, 3, 4, 5, 6, or 7 accesses per 24 hour period). Such a course of action may, for example, enable the system to prevent an unwanted human from mining data from a particular online retail web site, but still allow the unwanted human to patronize the online retail website (e.g., to shop on the online retail website outside the context of the user being an employee of a competitor). In other embodiments, the system may take any other suitable defensive action to block or otherwise limit the access to the website of the unwanted human.

Price Mining Prevention Module

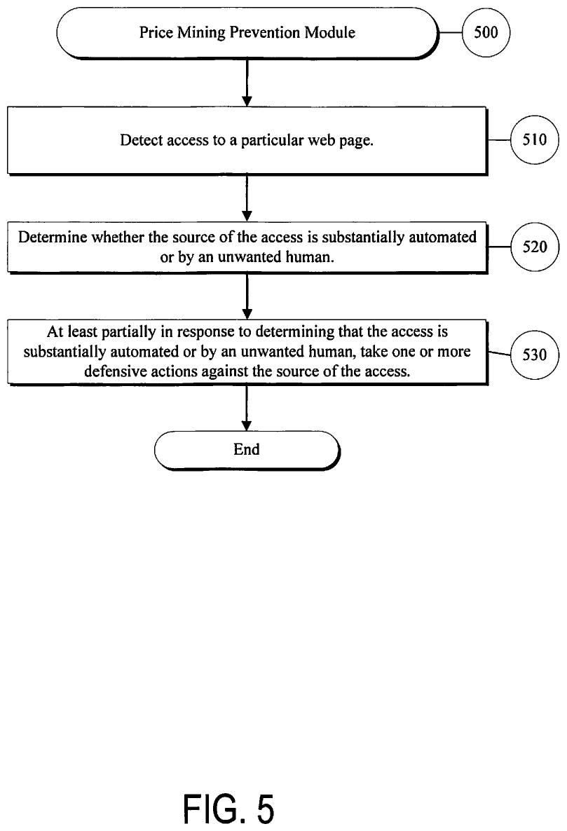

FIG. 5 is a flow diagram of an exemplary Price Mining Prevention Module 500. The Price Mining Prevention Module 500 may, for example, be implemented by a computer system such as the System 110 of FIG. 1. Turning again to FIG. 5, the system begins at Step 510 by detecting access to a particular web page. In various embodiments, the system is configured to detect access in response to receiving a request to access the particular web page. The request to access the web page may occur when the web page is accessed from a link provided by a search engine, when the web page is accessed from an advertising link on a separate web page, or when the web page is accessed directly from the web page address being entered into the address bar of a suitable internet browser.

In response to detecting access to the web page at Step 510, the system, in various embodiments, collects data associated with the source of the access such as: (1) IP address information; (2) operating system information; (3) web browser information; (4) one or more user agent strings; (5) one or more search terms used to identify and/or access the web page; (6) an advertising link used to access the web page; and/or (7) other information relating to the method used to access the web page and/or the source of the access. The system may, in particular embodiments, collect other information about the source of the access including an email address if the source has a registered account for the web page, or other information associated with the registered account such as, for example, a name of the user, an address of the user, etc.

Next, in Step 520, the system determines whether the access is substantially automated or by an unwanted human. In determining whether the access is substantially automated, the system, in various embodiments, may undergo the same process detailed in Step 320 in FIG. 3. Similarly, in determining whether the access is by an unwanted human, the system may undergo the same process detailed in Step 420 in FIG. 4.

Turning to FIG. 5, after completing Step 520, the system proceeds to Step 530 where, at least partially in response to determining that the source of the access may be substantially automated or by an unwanted human, the system take one or more defensive actions against the source of the access. Such defensive actions may include, for example, blocking access to the web page, requiring the source of the access to register for a user account, or requiring the source of the access to complete a CAPTCHA. Requiring the source to register with the web page may enable the system to collect more information about the source to determine with greater certainty that the source is an unwanted human. In addition, if no user account is created, the system may be configured to deny access to the web page. In various embodiments, the system is configured to block access at the router level, at the network level, on a software level, or in any other suitable manner.

In various embodiments the system is configured to further determine whether a source determined to be substantially automated is, in fact, unwanted. In such embodiments, the system may be configured to determine whether a substantially automated source is a favorable source, such as a search engine web crawler or other favorable source, which may, for example, direct or increase traffic to the particular web page. In such embodiments, the system is configured to determine whether the substantially automated source may be favorable, and, in response to determining that it may be favorable, not take any defensive action against that particular favorable automated source.

In other embodiments, the system is configured to provide access to a modified version of a web page to one or more sources of access that the system has determined to be unwanted. The system may, for example: (1) determine that a potentially unwanted source of access is attempting to access a particular web page; (2) at least partially alter data associated with the particular web page to create a modified web page; and (3) provide access to the unwanted source of access to the modified web page. In various embodiments, the data associated with the particular website that the system is configured to at least partially alter may include, for example, pricing information for a particular product, one or more specifications associated with a particular product, or any other suitable product or other data which an unwanted user may be attempting to ascertain.

In particular embodiments, the system is configured to alter pricing information for a particular product on a particular product web page so that the particular product web page displays incorrect pricing information (e.g., pricing information that is higher or lower than the actual price at which the product is offered for sale on the particular web page). In other embodiments, the system is configured to display the correct pricing information as an image rather than as text (e.g., which may, for example, make it more difficult for a source mining pricing information from easily ascertaining pricing information from the particular product page). In still other embodiments, the system is configured to not display any pricing information in response to determining that a potentially unwanted source of access is attempting to access the particular product page. In such embodiments, the system may be configured to allow an unwanted source of access to successfully mine incorrect data.

MAP Compliance Communication Module

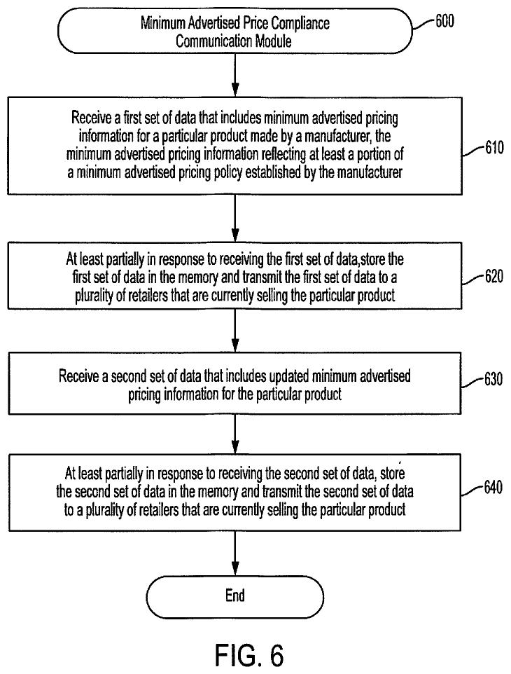

FIG. 6 is a flow chart of operations performed by an exemplary MAP Compliance Communication Module 600, which may, for example, run on the MAP Compliance Server 120, or any suitable computing device (such as a suitable mobile computing device). In particular embodiments, the MAP Compliance Communication Module 300 may facilitate the storing and distributing of MAP compliance data.

In various embodiments, the system begins at Step 610 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. The MAP policy may include MAP information for one or more products made by the manufacturer. The MAP information may include information such as price, date, geographic area, etc. for the MAP of a particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30.

Next, at Step 620, the system continues by, at least partially in response to receiving the first set of data, storing the first set of data in the memory and transmitting the first set of data to a plurality of retailers that are currently selling the particular product. In various embodiments, the system may be configured to substantially automatically store and transmit the first set of data to the plurality of retailers. In particular embodiments, the system may be configured to transmit the first set of data on a particular date, for example, the first day of every month.

At Step 630, the system receives a second set of data that includes updated MAP information for the particular product. For example, the updated MAP information for the particular product may raise the MAP from $100 to $110 due to high demand for the particular product. In various embodiments, the second set of data may include any suitable change to the first set of data, including changes to price, date, geographic area, etc. for the MAP of the particular product.

Continuing to Step 640, the system, at least partially in response to receiving the second set of data, stores the second set of data in the memory and transmits the second set of data to a plurality of retailers that are currently selling the particular product. In various embodiments, the system may be configured to substantially automatically store and transmit the second set of data to the plurality of retailers. In particular embodiments, the system may be configured to transmit the second set of data on a particular date, for example, the first day of every month.

MAP Compliance Policing Module

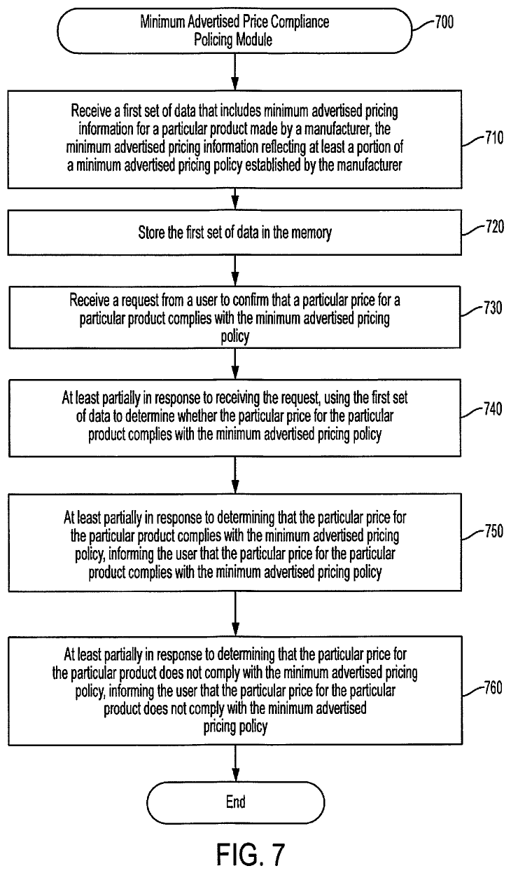

FIG. 7 is a flow chart of operations performed by an exemplary MAP Compliance Policing Module 700, which may, for example, run on the MAP Compliance Server 120, or any suitable computing device. In particular embodiments, the MAP Compliance Policing Module 700 may store MAP compliance data and inform a user as to whether a particular price violates a MAP policy.

Beginning at Step 710, the system receives a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $150 for the period between June 1 and July 31 and $125 for the period between August 1 and September 30. Thus, the first set of data may include information such as price, date, geographic area, etc. for the MAP of the particular product.

At Step 720, the system continues by storing the first set of data in the memory. In various embodiments, the system may be configured to substantially automatically store the first set of data in the memory.

Continuing to Step 730, the system receives a request from a user to confirm that a particular price for a particular product complies with the MAP policy. In various embodiments, the user is a competitor of a retailer that is offering the particular product at the particular price. For example, the user may want to confirm that its own price for a particular product complies with the MAP policy. In addition, the user may want to confirm that a competitor's price for a particular product complies with the MAP policy. In various embodiments, the request from the user may be to confirm that a proposed pricing structure would comply with the MAP policy. In particular embodiments, the request from the user may also be a request to notify the manufacturer of a violation of a MAP policy by the user.

Next, at Step 740, the system, at least partially in response to receiving the request from Step 730, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy.

The system continues at Step 750 by, at least partially in response to determining that the particular price for the particular product complies with the MAP policy, informing the user that the particular price for the particular product complies with the MAP policy. In various embodiments, the system may inform the user that the particular price for the particular product complies with the MAP policy via an electronic communication generated by the system. In some embodiments, the electronic communication may be substantially simultaneously to the request by the user. In other embodiments, the electronic communication may be by e-mail, text message, automated phone call, instant message or by any other suitable means of electronic communication.

At Step 760, the system, at least partially in response to determining that the particular price for the particular product does not comply with the MAP policy, informs the user that the particular price for the particular product does not comply with the MAP policy. In various embodiments, the system may inform the user that the particular price for the particular product does not comply with the MAP policy via an electronic communication generated by the system. In particular embodiments, after informing the user that the particular price does not comply with the MAP policy, the system may receive a dispute from the user disputing the violation of the MAP policy.

MAP Compliance Reporting and Enforcing Module

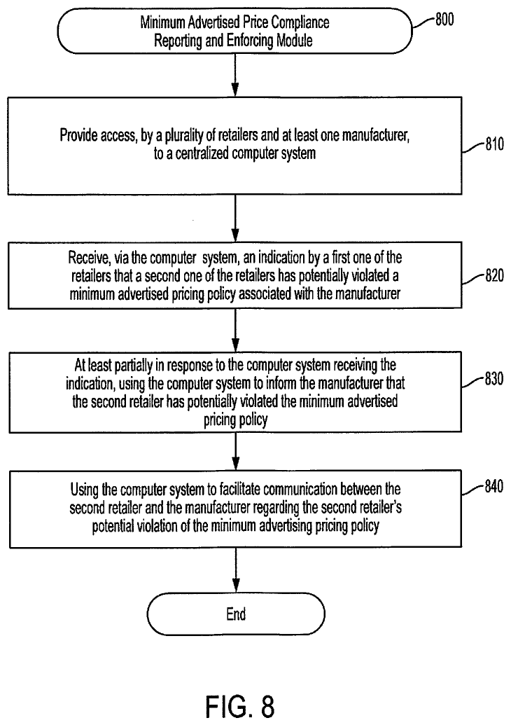

FIG. 8 is a flow chart of operations performed by an exemplary MAP Compliance Reporting and Enforcing Module 800, which may, for example, run on the MAP Compliance Server 120, or any suitable computing device. In particular embodiments, the MAP Compliance Reporting and Enforcing Module 800 may facilitate reporting and enforcing of MAP policies.

To begin with, at Step 810, the system provides access, by a plurality of retailers and at least one manufacturer, to a centralized computer system. Access to the computer system may be provided through the Internet, a LAN, a WAN, or any other suitable network that is adapted to facilitate communication between the retailers and the at least one manufacturer.

Continuing to Step 820, the system receives, via the computer system, an indication by a first one of the retailers that a second one of the retailers has potentially violated a MAP policy associated with the manufacturer. In particular embodiments, the indication may be an electronic communication between the first retailer and the system regarding the second retailer's alleged violation of the MAP policy.

At Step 830, the system, at least partially in response to the computer system receiving the indication, uses the computer system to inform the manufacturer that the second retailer has potentially violated the MAP policy. In various embodiments, the system may inform the manufacturer of the second retailer's violation by electronic communication. For example, after receiving the indication from the first retailer, the system may send the first retailer's note directly to the manufacturer. In other embodiments, the system may inform the manufacturer using a pop-up notification, e-mail notification, an instant message, a text message, an automated phone message where the user presses a key to indicate that the understand the message, or any other suitable means of electronic communication.

Following Step 830, at Step 840, the system uses the computer system to facilitate communication between the second retailer and the manufacturer regarding the second retailer's potential violation of the MAP policy. In various embodiments, the system may facilitate communication by electronic communication. Such communications may include, for example: (1) a communication from the manufacturer to the second retailer that includes the MAP policy and the alleged violation of the MAP policy including the actual price used by the second retailer for the particular product; (2) a communication from the second retailer to the manufacturer that includes the second retailer's position as to why the second retailer's pricing of the particular product does not violate the manufacturer's MAP policy; and (3) a response to this communication from the manufacturer as to whether the manufacturer still believes, after reviewing the communication from the second retailer, that the second retailer's pricing of the item violates the manufacturer's MAP policy for the particular item. This step allows the second retailer and the manufacturer to resolve any alleged MAP violations. Following the resolution of the second retailer's alleged MAP violation, in various embodiments, the system may inform the first retailer as to the outcome of the communications between the second retailer and the manufacturer regarding the second retailer's alleged violation of the MAP policy.

MAP Compliance Monitoring Module

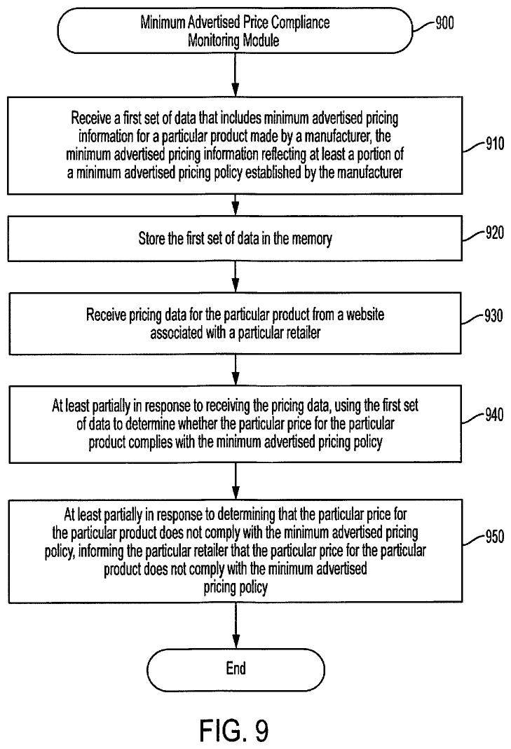

FIG. 9 is a flow chart of operations performed by an exemplary MAP Compliance Monitoring Module 900, which may, for example, run on the MAP Compliance Server 120, or any suitable computing device. In particular embodiments, the MAP Compliance Monitoring Module 900 may store MAP compliance data, directly monitor compliance with MAP policies, and facilitate enforcement of MAP policies.

In various embodiments, the system begins at Step 910 by receiving a first set of data that includes MAP information for a particular product made by a manufacturer, the MAP information reflecting at least a portion of a MAP policy established by the manufacturer. In particular embodiments, the system may be configured to receive the first set of data from any suitable computing device. In various embodiments, the MAP policy may, for example, have been established by a manufacturer of the particular product. In particular embodiments, the MAP information may include, for example, a MAP for the particular product for a particular geographical area. In various embodiments, the MAP information may include, for example, a MAP for the particular product for a particular time period. For example, the MAP for a particular product may be set at $100 for the period between June 1 and July 31 and $85 for the period between August 1 and September 30. Thus, the first set of data may include information such as price, date, geographic area, etc. for the MAP of the particular product.

At Step 920, the system stores the first set of data in the memory. In various embodiments, the system may be configured to substantially automatically store the first set of data in the memory.

Next, at Step 930, the system receives pricing data for the particular product from a website associated with a particular retailer. In particular embodiments, the system may receive general pricing data from the retailer's website by conducting a search on the retailer's website for the particular product from any computer. In various embodiments, the system may receive pricing data using a computer located in a particular region to access the website. For example, some retailers may offer one or more products at different prices based at least in part on a location from which a customer's computer accesses the retailer's website. In such embodiments, the system may be configured to provide pricing information to the manufacturer that includes the pricing information for the one or more regions or geographic locations.

Continuing to Step 940, the system, at least partially in response to receiving the pricing data, uses the first set of data to determine whether the particular price for the particular product complies with the MAP policy. In various embodiments, the system may compare the particular price with a MAP established by the MAP policy and in response to the particular price being greater than or equal to the MAP, determine that the particular price for the particular product complies with the MAP policy. In particular embodiments, the system may compare the particular price with a MAP established by the MAP policy and in response to the particular price being less than the MAP, determine that the particular price for the particular product does not comply with the MAP policy. In various embodiments where the system obtains different retailer pricing based on differing geographic access points, the system may be configured to check each price against the MAP policy since the MAP policy may contain different price points based on geographic location.

At Step 950, at least partially in response to determining that the particular price for the particular product does not comply with the MAP policy, informing the particular retailer that the particular price for the particular product does not comply with the MAP policy. In various embodiments, the system may inform the user that the particular price for the particular product does not comply with the MAP policy via an electronic communication generated by the system. In particular embodiments, the system may inform the retailer about all MAP violations at the same time, for instance, at the end of every day, or in the alternative, the system may notify the retailers of MAP noncompliance substantially automatically when a price does not comply. In various embodiments, the system may bundle all non-complying prices for all products into a single notification to the retailer. In other embodiments, the system may show all prices that comply with a MAP policy in green and all prices that do not comply with a MAP policy in red so that the user can easily distinguish those prices in compliance from those prices that are out of compliance. In various embodiments, the system may be configured to automatically monitor the particular price for the particular product at present intervals, continuously or manually. In any case, the system may be configured to notify the retailer when the system detects that the particular price for the particular product is not in compliance with the MAP policy.

### Illustrative Examples

### Exemplary Experience of the Automated Access Determination Module

The following describes an exemplary experience of the Automated Access Determination Module 300. In this example, to start, the system begins by determining that a user has accessed a particular web page, for instance, the home page of Amazon.com. The system then gathers information about the user including the user's IP address. In attempting to determine whether the user is an automated user such as a bot, the system prompts the user to complete a CAPTCHA. If the user fails to complete the CAPTCHA, the system blocks the user's access to the web page by blocking access to the IP address of the user.

### Exemplary Experience of the Unwanted Human Access Determination Module

The following describes an exemplary experience of the Unwanted Human Access Determination Module 400. To begin, the system detects that a user has accessed a particular web page such as Amazon.com. In this case, the user sets up a user account with Amazon.com, entering information that includes, for example, the user's email address, name, address, phone number, etc. This allows the system to search other websites such as Facebook using the name or email address listed by the user in setting up the user's Amazon.com account. Upon determining from the user's Facebook account that the user is employed by Wal-Mart, the system can flag the user as a potential unwanted human and track the user's activity on Amazon.com to determine whether the user is simply shopping on the website, or if the user is going through product listings more systematically so that it appears the user is mining Amazon.com for product pricing information. If the system determines that the user's search pattern is not reflective of the user simply shopping on the website, the system may determine an appropriate defensive action based on the activity of the user and implement the defensive action against the user.

The system may, for example: (1) receive user information from a user creating an account on a particular e-commerce website; (2) use the user information to access additional information associated with the user (e.g., the user's employer information) from a social media account associated with the user or other publicly available information associated with the user; and (3) determine whether to at least partially limit access to one or more web pages based at least in part on the employer information or other additional information.

### Exemplary User Interfaces

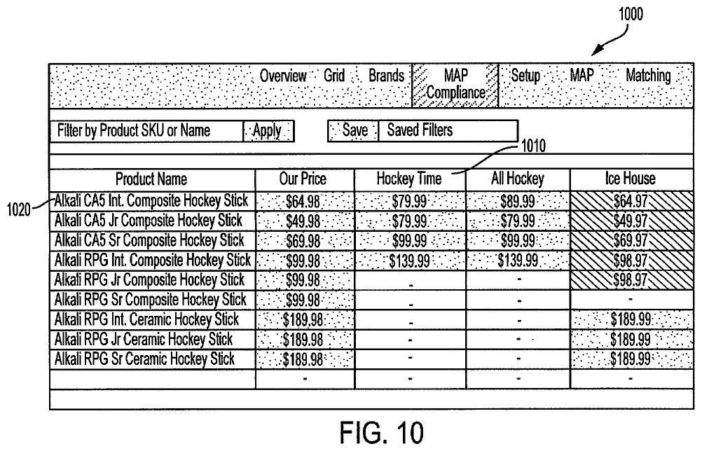

FIG. 10 depicts a user interface 1000 that a user may use to confirm compliance with one or more MAP policies. As may be understood from this figure, the interface 1000 may include one or more competitor columns 1010 that the user may use to confirm whether one or more particular competitors are complying with a particular MAP policy for a particular product. In particular embodiments, the interface 1000 may further include a color scheme using red (shown by the cross-hatched lines) for noncompliance and green (shown as shaded) for compliance, which corresponds generally to the colors of a stop light, and allow the user to quickly assess the overall compliance with a particular MAP policy for a particular product. For example, the first row 1020 shows that the user's company is currently charging $64.98 for the product Alkali CA5 Int. Composite Hockey Stick, while the competitor Hockey Time is charging $79.99 and the competitor Ice House is charging $64.97 for the product. Also, assume the manufacturer has set a MAP of $64.98 in the manufacturer's MAP policy. Because the competitor Hockey Time's price is above the particular MAP, the competitor's price is shown shaded. However, because the competitor Ice House's price is below the particular MAP, that competitor's price is shown with cross-hatching. In this way, the user can easily identify pricing that is compliance and pricing that violates the manufacturer's MAP.

MAP Compliance Communication Module User Experience

The following describes an exemplary user experience using the MAP Compliance Communication Module 600. To begin with, a manufacturer will have an established MAP policy that will designate a particular MAP for a particular product. For instance, manufacturer Acme Bats may have a product, the Bomber 2000, with a nationwide MAP policy for the bat of $49.99. The manufacturer, by accessing a MAP Compliance Server 120, may enter the MAP policy into the system using their computer (e.g., a manufacturer's computer, such as manufacturer computer 164 shown in FIG. 1). The system will store the particular MAP policy of $49.99 for the Bomber 2000 as well as send out a notification of the current MAP via the one or more networks 115 to all the retailers currently selling the Bomber 2000. The retailers would then be able to see the MAP for the Bomber 2000 by logging onto their computer (e.g., a retailer's computer, such as retail computer 162 shown in FIG. 1).

If the manufacturer decides to update the MAP for the Bomber 2000, for instance to lower the price of the MAP, the manufacturer may log onto the system and access the MAP Compliance Server 120 in the same way as before. The manufacturer may then enter the new MAP policy of $39.99, for example using their computer. Once the manufacturer has changed the MAP from $49.99 to $39.99 MAP, the system will automatically send out a notification of the new MAP to all the retailers selling the particular product. The retailers may receive this notification the next time they log onto the system or via email depending upon the retailer's preferences. Using this system, for example, the manufacturer may raise or lower the MAP, discontinue using the MAP, or change other specifics related to the MAP such as geographic information or dates. Because this is an automatic update to all of the retailer's user interfaces, retailers currently selling the particular product will not have to search for the current MAP for the particular product.

MAP Compliance Policing Module User Experience

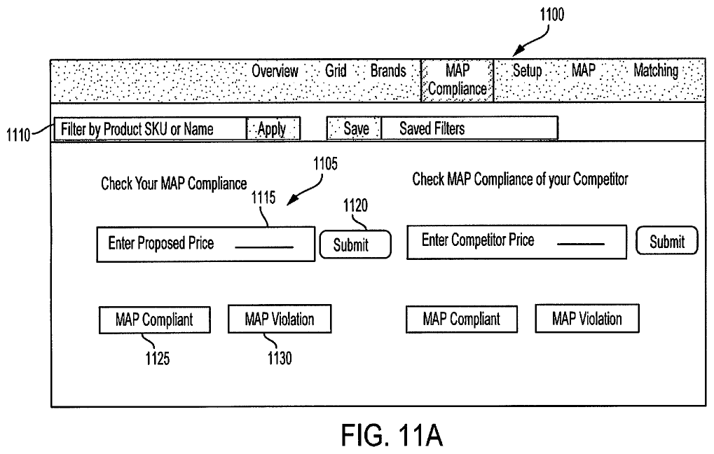

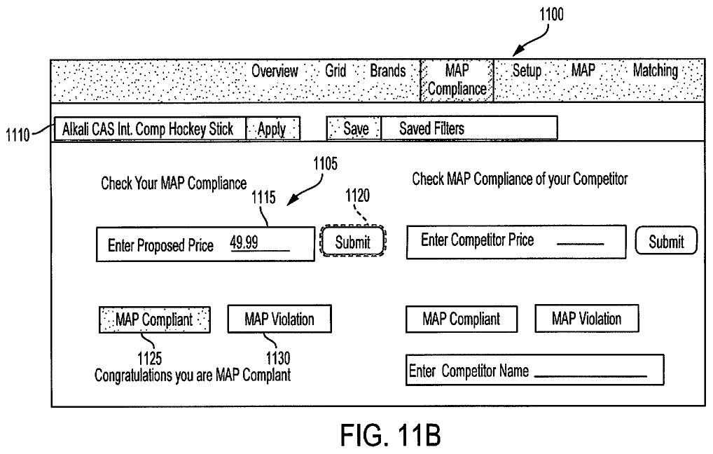

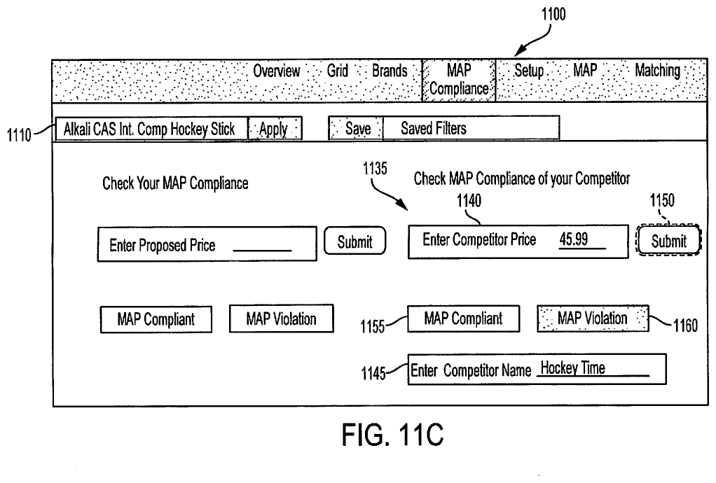

The following describes an exemplary user experience using the MAP Compliance Policing Module 700. Using this module allows retailers looking to raise or lower the price of a particular product, for example the Alkali CA5 Int. Comp Hockey Stick, to confirm that the new price will comply with the manufacturer's MAP policy. For example, a particular sporting goods retailer, Hockey R Us, may wish to sell the Alkali CA5 Int. Comp Hockey Stick made by the manufacturer Alkali. Hockey R Us may wish to offer the Alkali CA5 Int. Comp Hockey Stick at a very low “loss leader” price in order to attract more customers to its store. For instance, Hockey R Us is currently selling the Alkali CA5 Int. Comp Hockey Stick for $64.98 but would like to lower its price to attract customers away from its competitor, Hockey Time. Using this system and referring to FIG. 11A, an employee of Hockey R Us is able to log onto the system using the store's computer (e.g., a retailer's computer, such as retailer computer 162 shown in FIG. 1) and open a User Interface 1100. The User interface 1100 has a first section 1105 that allows a retailer to check its compliance with a manufacturer's MAP. In particular, first section 1105 has a product entry field 1110, a proposed price entry field 1115, a submit button 1120, a MAP Compliant indicator 1125, and a MAP Violation indicator 1130. Referring to FIG. 11B, the Hockey R Us employee may then enter the new desired price, $49.99, for the Alkali CA5 Int. Comp Hockey Stick into the system and hit the submit button 1120. Because the manufacturer, Alkali, set the MAP for the Alkali CA5 Int. Comp Hockey Stick at $49.99, the system will notify the retailer that the new price complies with the MAP policy highlighting the MAP Compliant indicator 1125 as shown in the figure. In addition, this module enables the retailer to enter any price, whether current, proposed, or that of a competitor, to determine whether the price complies. The system also allows the retailer to set up notifications for instances where the retailer's price or the competitor's price falls below the manufacturer's MAP.

MAP Compliance Reporting and Enforcing Module User Experience

The following describes an exemplary user experience using the MAP Compliance Reporting and Enforcing Module 800. This feature of a particular embodiment enables a first retailer to police the prices used by a second retailer and allows the first retailer to report a potential violation of a MAP policy by the second retailer. For example, Hockey R Us may have seen an ad by its competitor, Hockey Time, listing the Alkali CA5 Int. Comp Hockey Stick for $45.99. Because Hockey R Us also sells the Alkali CA5 Int. Comp Hockey Stick, it may wish to confirm that Hockey Time is complying with Alkali's MAP policy for the Alkali CA5 Int. Comp Hockey Stick. Using the system, a Hockey R Us employee may log onto the system and be directed to a user interface 1100 shown in FIG. 11C that has a second section 1135 that allows the user to check the compliance of a competitor to a manufacturer's MAP policy. Using this user interface, the Hockey R Us employee may enter the product name, Alkali CA5 Int. Comp Hockey Stick, in the product name entry field 1110. The employee also enters the competitor's price, $45.99, in the price field 1140 and the competitor's name, Hockey Time, in the name field 1145. Once the data is entered, the user selects the submit button 1150 to send the data to the system for analysis. In this example, because Hockey Time's price is below Alkali's MAP for the Alkali CA5 Int. Comp Hockey Stick, the MAP Violation indicator 1160 is highlighted while the MAP compliance indicator 1155 is not. The system may then provide the option to Hockey R Us to notify Alkali of Hockey Time's potential violation, or in other embodiments, the system may automatically send Alkali the information when a MAP violation is detected. The system will then allow Alkali to open up a communication box between itself and Hockey Time to resolve the violation. Hockey Time may respond to this communication directly or may respond indirectly by changing its price for the Alkali CA5 Int. Comp Hockey Stick. Once the violation has been resolved, Alkali may close the communication box and may select whether it wants to send the resolution of the violation to the notifying retailer, Hockey R Us.

MAP Compliance Monitoring Module User Experience

The following describes an exemplary user experience using the MAP Compliance Monitoring Module 900. In this embodiment, the system automatically monitors the pricing of particular products offered by a particular retailer on the retailer's website. For example, the MAP Compliance Server 120 will access the one or more networks 115 and perform a search for a specific retailer's website, for instance Hockey R Us and Hockey Time. If after accessing the retailers' websites, the system determines that Hockey Time is selling the Alkali CA5 Int. Comp Hockey Stick for $45.99 and Hockey R Us is selling the Alkali CA5 Int. Comp Hockey Stick for $49.99, while Alkali's MAP policy for the Alkali CA5 Int. Comp Hockey Stick is $49.99, the system will automatically generate a notification to Hockey Time and the communication process discussed above will ensue until the violation is resolved.

Finally, a retailer may use the system to retrieve a full listing of all of its products in a certain area to make sure that there are no holes in the retailer's inventory. For instance, using the user interface 1000 shown in FIG. 10, Hockey R Us may access the grid showing all of Hockey R Us' products in the first column 1020, Hockey R Us' prices in the next column, and all competitors selling the same products in the following columns. After running the search for its products, if the first column displays a line for a particular product, Hockey R Us will be able to update the pricing for that particular product.

### Exemplary Advantages of Various Embodiments

Certain embodiments may have particular advantages to one or more retailers or manufacturers. However, not all advantages will be duly applicable to all users or in all situations. The following discusses advantages that may be realized by some manufacturers using particular embodiments. First, the system will allow manufacturers to detect source MAP violations, which will help to improve the quality of MAP enforcement and will make finding such violations easier for the manufacturers. In addition, certain embodiments will allow manufacturers to quickly and effectively update and distribute changes to MAP policies to all retailers using a single computer system.

Similarly, certain embodiments may have particular advantages to one or more retailers. For instance, certain retailers may find certain embodiments to be an effective platform for reporting competitors' violations of MAP policies. Other retailers may find that certain embodiments provide a beneficial platform for quickly and effectively addressing and resolving their own potential MAP violations. Still other retailers may find that certain embodiments provide an effective platform for keeping up to date on manufacturers' product lines and MAP policies. Each of these various advantages will create a more centralized and more effective process that will in turn enable better policing, monitoring, communication, and enforcement regarding manufacturers' MAP policies.

### Alternate Embodiments

Various embodiments of a system for preventing price-mining and other data-mining may include features in addition to those features described above. Such alternative embodiments are described below.

Blacklisting Particular Sources

In various embodiments, the system is configured to blacklist particular sources of access (e.g., particular users, particular IP addresses, etc.) substantially without having to determine whether the source is an unwanted source. In such embodiments, the system may be configured to: (1) receive a listing of one or more sources to blacklist; and (2) substantially automatically block any attempted access by the one or more sources. In such embodiments, the system may be configured to receive the listing of one or more sources to blacklist from, for example, a company that has hired a third party company to prevent price mining on its web page, or from any other suitable source. In particular embodiments, the system may be adapted to automatically compile the blacklist by searching the Internet and/or other sources for indications that particular individuals are employed, in a potential price mining capacity, by one or more entities, such as competitors of the company, and then adding those particular individuals to the blacklist.

In other embodiments, the system may be configured to create a blacklist by, for example, using publicly available information to determine a list of employees of a particular competitor (e.g., via LinkedIn or another social media website, via the competitor's web page, etc.). In various embodiments, the system is configured to determine a blacklist of one or more individuals based at least in part on particular competitor employee's position with the competitor. For example, the system may be configured to blacklist all IT employees of a particular competitor or blacklist any other suitable employees of a competitor who may be involved (e.g., based at least in part on their position with the competitor) in price mining or other competitive activity.

Public Review and Forum Post Scanning

In various embodiments, the system is configured to scan reviews posted on one or more public web sites as well as posts made on one or more public message boards to determine whether the reviewer or the message board poster may be employed by a competitor or other third party company whose employees may engage in price mining. In such embodiments, the system may be configured to determine that the poster or reviewer is such an individual based at least in part on, for example: (1) content of the post or review; (2) a product or company for which the reviewer has made the review; (3) a topic of the message board; and/or (4) any other suitable factor.

In particular embodiments, the system may determine that a particular poster or reviewer is employed by a particular competitor by, for example, searching a post or review by the particular poster or reviewer for a particular word (e.g., or string of words) which may indicate that the poster or reviewer is employed by the particular competitor. For example, the system may search for instances in a post or review where the poster or reviewer mention an experience while employed by the competitor. In other embodiments, the system is configured to search a plurality of posts or reviews by the same poster or reviewer to ascertain that the poster or reviewer is an employee of the particular competitor. For example, a particular reviewer may post messages to a message board that includes references to their experience as a network administrator. The same reviewer may have posted several reviews for restaurants in Redmond, Wash. The system may, based on this information, determine that the reviewer is an employee of Microsoft, based on their job role and their frequent visits to Microsoft's city of headquarter. In response to determining that a poster or reviewer may be employed by a competitor or other unwanted company, the system may, for example: (1) determine the poster or reviewer's IP address, name, e-mail address; and (2) add that poster or reviewer to a blacklist to block access to that poster or reviewer.

### CONCLUSION

Many modifications and other embodiments of the invention will come to mind to one skilled in the art to which this invention pertains having the benefit of the teachings presented in the foregoing descriptions and the associated drawings. For example, instead of having a separate user interface 1100 that allows the user to enter pricing to check compliance with a MAP, the user may engage the user interface 1000 for reporting MAP violations. In particular, when a price is shown with cross hatching (e.g., is red), the user may click on that particular pricing to send a note to the manufacturer. Additionally, an additional column may be added to the user interface 1000 that allows a user to input a proposed price for a particular item, which then causes the system to check the proposed price against the manufacturer's MAP policy for that item. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer system for processing managing compliance data associated with one or more minimum advertised pricing policies, the system comprising:
a. at least one processor; and
b. memory, wherein said computer system is configured for:
i. receiving a first set of data that includes minimum advertised pricing information for a particular product made by a manufacturer, the minimum advertised pricing information reflecting at least a portion of a minimum advertised pricing policy established by the manufacturer;
ii. storing the first set of data in said memory;
iii. receiving a request, from a user, to confirm that a particular price for a particular product complies with the minimum advertised pricing policy;
iv. at least partially in response to receiving the request, the at least one processor using the first set of data to determine whether the particular price for the particular product complies with the minimum advertised pricing policy; and
v. at least partially in response to determining that the particular price for the particular product complies with the minimum advertised pricing policy, one of:
a. informing the user that the particular price for the particular product complies with the minimum advertised pricing policy; and
b. informing the user that the particular price for the particular product does not comply with the minimum advertised pricing policy.

2. The computer system of claim 1, wherein the step of using the first set of data to determine whether the particular price for the particular product complies with the minimum advertised pricing policy comprises:
a. comparing the particular price with a minimum advertised price established by the minimum advertised pricing policy; and
b. in response to the particular price being greater than or equal to the minimum advertised price, determining that the particular price for the particular product complies with the minimum advertised pricing policy.

3. The computer system of claim 1, wherein the step of receiving the first set of data comprises receiving the first set of data from the manufacturer.

4. The computer system of claim 3, wherein the user is a retailer that is offering the particular product for sale at the particular price.

5. The computer system of claim 3, wherein the user is a competitor of a retailer that is offering the particular product at the particular price.

6. The computer system of claim 1, wherein the computer system is adapted for allowing the manufacturer to electronically update the minimum advertised pricing policy.

7. The computer system of claim 1, wherein the computer system is adapted for:
a. receiving, from the manufacturer, a request to notify a particular retailer of an alleged violation, by the retailer, of a minimum advertised pricing policy associated with the manufacturer; and
b. at least partially in response to receiving the request, notifying the particular retailer of the alleged violation.

8. The computer system of claim 7, wherein the computer system is adapted for:
a. after the step of notifying the particular retailer of the particular retailer's violation of the minimum advertised pricing policy, receiving, from the particular retailer, a dispute of the manufacturer's assertion that the particular retailer has violated the minimum advertised pricing policy; and
b. at least partially in response to receiving the dispute, notifying the manufacturer of the dispute.

9. A method of processing minimum advertised pricing policy data, the method comprising:
a. providing access, by a plurality of retailers and at least one manufacturer, to a centralized computer system comprising a memory and one or more computer processors;
b. receiving, via the computer system, an indication, by a first one of the retailers, that a second one of the retailers has potentially violated a minimum advertised pricing policy associated with the manufacturer;
c. at least partially in response to the computer system receiving the indication, using the computer system to inform the manufacturer that the second retailer has potentially violated the minimum advertised pricing policy; and
d. using the computer system to facilitate communication between the second retailer and the manufacturer regarding the second retailer's potential violation of the minimum advertised pricing policy.

10. The method of claim 9, further comprising informing the first retailer as to an outcome of communications between the second retailer and the manufacturer regarding the second retailer's potential violation of the minimum advertised pricing policy.

11. The method of claim 9, wherein the step of receiving an indication further comprises:
a. presenting, by the computer system, to the first one of the retailers a listing of products;
b. presenting, by the computer system, to the first retailer at least one respective price for each product in the listing of products for the second retailer; and
c. providing a link, by the computer system, that is configured to allow the first retailer to select a particular one of the listing of products where the second retailer is in violation of the manufacturer's minimum advertised pricing policy.

12. The method of claim 9, wherein the step of informing the manufacturer further comprises sending an electronic communication to the manufacturer.

13. The method of claim 12, wherein the communication is chosen from a group consisting of:
a. an e-mail message;
b. a text message;
c. a pop-up message; and
d. an instant message.

14. The method of claim 9, wherein the step of using the computer system to facilitate communication between the second retailer and the manufacturer further comprises generating an electronic communication exchange between the second retailer and the manufacturer.

15. The method of claim 14, wherein the electronic communication exchange is carried out using a communication method chosen from a group consisting of:
a. e-mail;
b. text messaging;
c. automated phone call; and
d. instant messaging.

16. A computer system for processing minimum advertised pricing policy compliance data, the system comprising:
a. at least one processor; and
b. memory, wherein said computer system is configured for:
i. receiving a first set of data that includes minimum advertised pricing information for a particular product made by a manufacturer, the minimum advertised pricing information reflecting at least a portion of a minimum advertised pricing policy established by the manufacturer;
ii. at least partially in response to receiving the first set of data:
storing the first set of data in said memory; and
transmitting the first set of data to a plurality of retailers that are currently selling the product;
iii. receiving a second set of data that includes updated minimum advertised pricing information for the particular product; and
iv. at least partially in response to receiving the second set of data:
storing the second set of data in said memory; and
transmitting the second set of data to a plurality of retailers that are currently selling the product.

17. The computer system of claim 16, wherein the computer system is adapted for:
a. receiving a request, from a first one of the plurality of retailers, to confirm that a particular price for a particular product complies with a minimum advertised price contained in the second set of data;
b. at least partially in response to receiving the request from the first one of the plurality of retailers, comparing the particular price with the minimum advertised price; and
c. in response to the particular price being greater than or equal to the minimum advertised price, determining that the particular price for the particular product complies with the second set of data.

18. The computer system of claim 16, wherein the computer system is adapted for generating a table that comprises:
a. a listing of products from the manufacturer;
b. a corresponding price for each one of the products for at least a first retailer; and
c. an indication of whether the listed price is greater than or equal to a minimum advertised price associated with one of the first set of data and the second set of data.

19. The computer system of claim 18, wherein the generated table further comprises a corresponding price for each one of the products for a second retailer and a link that is configured to allow the first retailer to submit a potential minimum advertised price violation to the manufacturer.

20. The computer system of claim 19, wherein the computer system is further adapted to notify the manufacturer of a potential minimum advertised price violation when the link is activated by the first retailer.

21. The computer system of claim 16, wherein the computer system is adapted for:
a. automatically monitoring a price of a particular product offered by one or more of the plurality of retailers;
b. determining when the price of the particular product for at least one of the one or more of the plurality of retailers is less than one of the minimum advertised pricing information and the updated minimum advertised pricing information; and
c. notifying the at least one of the one or more of the plurality of retailers that its price of the particular product is less than the one of the minimum advertised pricing information and the updated minimum advertised pricing information.
